(19) United States
(12) Patent Application Publication
(10) Pub. No.: US 2013/0163178 A1
(43) Pub. Date: Jun. 27, 2013

(54) BASE ASSEMBLY AND RECORDING DISK DRIVING DEVICE INCLUDING THE SAME

(71) Applicant: Il Geun JEON, Hwaseong (KR)

(72) Inventor: Il Geun JEON, Hwaseong (KR)

(73) Assignee: SAMSUNG ELECTRO-MECHANICS CO., LTD, Suwon (KR)

(21) Appl. No.: 13/406,870

(22) Filed: Feb. 28, 2012

(30) Foreign Application Priority Data
Dec. 23, 2011 (KR) 10-2011-0141673

(51) Int. Cl. G06F 1/16; F16M 13/00

(52) U.S. Cl. 361/679.33; 248/346.01

(57) ABSTRACT

There is provided a base assembly including: at least one coupling member provided with insertion holes into which fastening members are inserted; and a press base formed by press processing and including insertion parts each formed in positions corresponding to those of the insertion holes and having the fastening members inserted thereinto in order to mount the coupling member, wherein each of the insertion parts is provided with a fastening hole into which the fastening member is inserted and is bent to overlap so as to have a mutual contact part extended and protruded from an upper surface of the press base.

### CROSS-REFERENCE TO RELATED APPLICATIONS

This application claims the priority of Korean Patent Application No. 2011-0141673 filed on Dec. 23, 2011, in the Korean Intellectual Property Office, the disclosure of which is incorporated herein by reference.

### BACKGROUND OF THE INVENTION

1. Field of the Invention

The present invention relates to a base assembly and a recording disk driving device including the same.

2. Description of the Related Art

A hard disk drive (HDD), an information storage device of a computer, reads data stored on a disk or writes the data to the disk using a magnetic head.

In this hard disk drive, a base includes a head driver installed thereon, that is, a head stack assembly (HSA), capable of moving a position of the magnetic head on the disk. The magnetic head performs its function while moving to a required position in a state in which it is floated from a writing surface of the disk at a predetermined height by the head driver.

According to the related art, a base provided in the hard disk drive has been manufactured in a scheme of die-casting aluminum (Al) and then completing an important shape through post-processing.

However, in the die-casting scheme according to the related art, since a process of injecting aluminum (Al) for forging in a molten liquid state to form a form is performed, relatively high temperature and pressure are required, such that a large amount of energy is required in the process and a process time is increased.

Further, in terms of a lifespan of a die-casting mold, there is a limitation in manufacturing a large number of bases using a single mold, and a base manufactured by the die-casting process has poor dimensional precision.

Therefore, in order to solve defects of the die-casting process, the base has been manufactured using a press process. However, in the case of manufacturing the base by the press process, the base has limitation of basically having a uniform thickness due to a process of pressing and bending a plate.

Therefore, in a case of fastening components for driving a hard disk drive to the base manufactured by the press process, a defect may occur in implementing coupling parts. In addition, even in a case of implementing the coupling parts, complete sealing of an inner portion of the hard disk drive should not be affected by the coupling parts.

In addition, in a case in which a plurality of coupling parts are formed to be adjacent to each other in order to be fastened to components for driving a hard disk drive, it may be very difficult to form the plurality of coupling parts as described above in the base manufactured by the press process.

Further, since the fastening parts have a uniform thickness, coupling force between the component and the base is weak. In a case in which a shape of the coupling part is changed in order to solve this defect, a region to which a sealing tape for sealing is to be attached increases, such that manufacturing costs increase.

The following Patent Documents 1 and 2 disclose a recoding disk driving device including a base.

### RELATED ART DOCUMENT

(Patent Document 1) Japanese Patent Laid-Open Publication No. 2000-245122
(Patent Document 2) Japanese Patent Laid-Open Publication No. 2002-335084

### SUMMARY OF THE INVENTION

An aspect of the present invention provides a base assembly able to be manufactured at relatively low costs simultaneously with increasing coupling force between a press base and a coupling member, and a recording disk driving device including the same.

According to an aspect of the present invention, there is provided a base assembly including: at least one coupling member provided with insertion holes into which fastening members are inserted; and a press base formed by press processing and including insertion parts each formed in positions corresponding to those of the insertion holes and having the fastening members inserted thereinto in order to mount the coupling member, wherein each of the insertion parts is provided with a fastening hole into which the fastening member is inserted and is bent to overlap so as to have a mutual contact part extended and protruded from an upper surface of the press base.

The press base may be provided with a dent part formed in a lower end portion of the insertion part and having a sealing member insertedly mounted therein.

The insertion part may be provided with a notch formed in an upper portion of the mutual contact part and facilitating bending of the insertion part in a case in which the insertion part is bent to overlap.

A cross section of the notch may have a square shape or a trapezoidal shape.

The insertion part may have an inner diameter smaller than that of the insertion hole to thereby press the fastening member.

According to another aspect of the present invention, there is provided a recording disk driving device including: a base assembly including at least one coupling member provided with insertion holes into which fastening members are inserted and a press base including insertion parts each formed in positions corresponding to those of the insertion holes and having the fastening members inserted thereinto in order to mount the coupling member; a head stack assembly rotatably installed on the press base; and a spindle motor installed on the press base so as to be spaced apart from the head stack assembly, wherein each of the insertion parts is provided with a fastening hole into which the fastening member is inserted and is bent to overlap so as to have a mutual contact part extended and protruded from an upper surface of the press base.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a base assembly according to an embodiment of the present invention;

FIG. 2 is an exploded perspective view showing the base assembly according to the embodiment of the present invention;

FIG. 3 is an enlarged cross-sectional view showing part A of FIG. 1;

FIG. 4 is an enlarged cross-sectional view showing a modified example of part A of FIG. 1; and

FIG. 5 is an exploded perspective view showing a recording disk driving device according to the embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification and removal of components within the same spirit, but those are construed as being included in the spirit of the present invention.

Further, when it is determined that the detailed description of the known art related to the present invention may obscure the gist of the present invention, the detailed description thereof will be omitted.

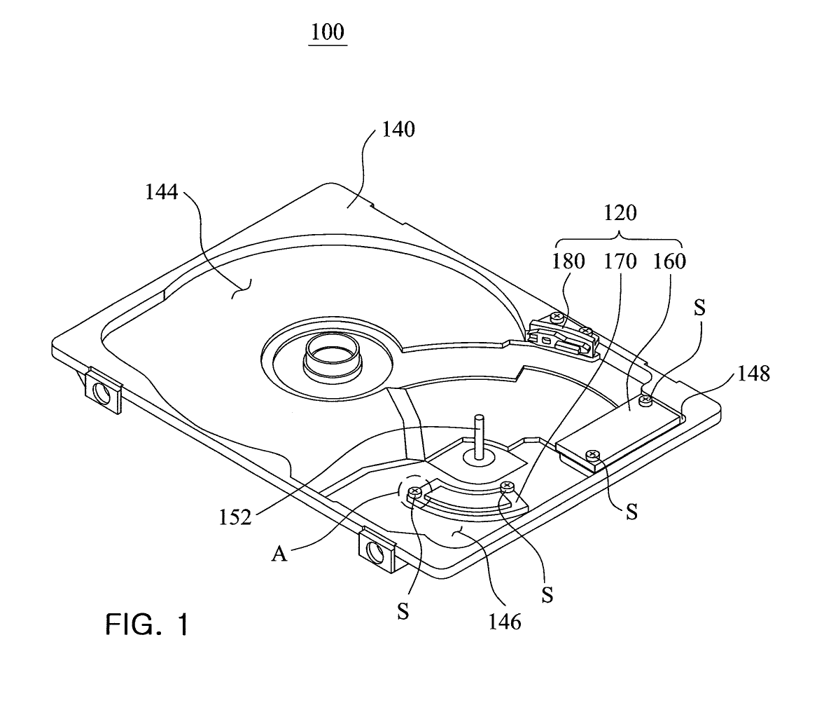

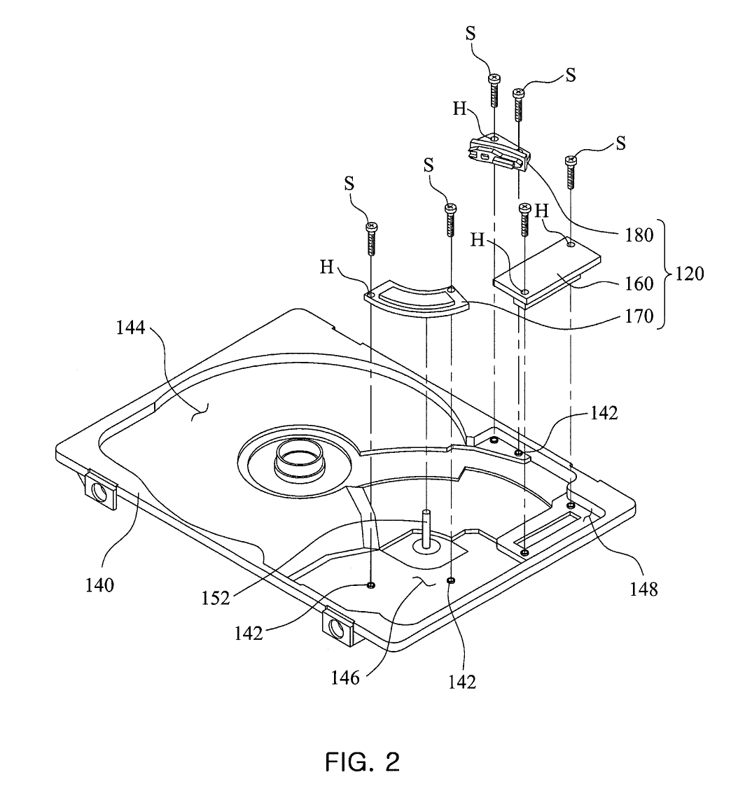

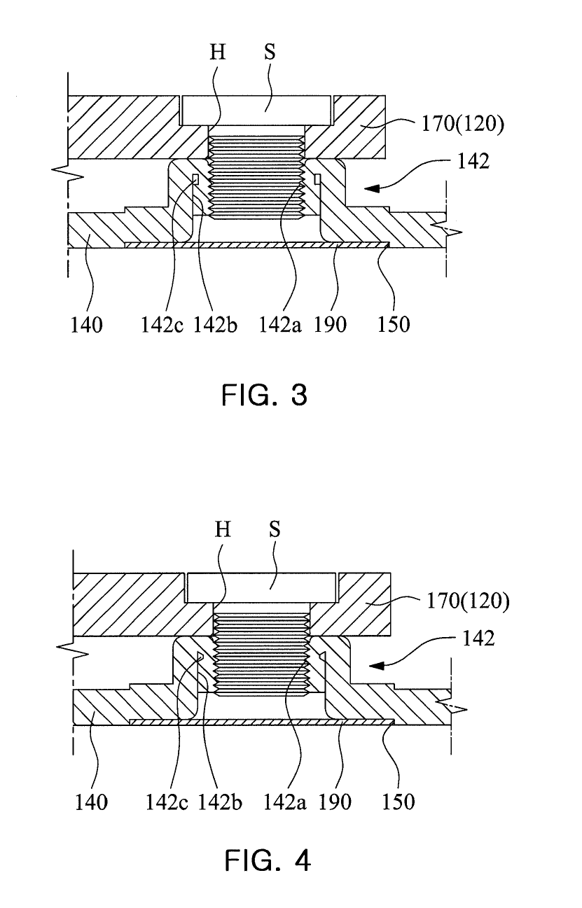

FIG. 1 is a schematic perspective view showing a base assembly according to an embodiment of the present invention; FIG. 2 is an exploded perspective view showing the base assembly according to the embodiment of the present invention; and FIG. 3 is an enlarged cross-sectional view showing part A of FIG. 1.

Referring to FIGS. 1 through 3, a base assembly 100 according to an embodiment of the present invention may include a coupling member 120 and a press base 140 by way of example.

The coupling member 120 may be provided with insertion holes H into which fastening members S are inserted. In addition, at least one coupling member 120 may be fixedly installed on the press base 140.

Meanwhile, the fastening member S may be a screw, and the coupling member 120 provided with the insertion holes H may include screw parts (not shown) formed therein in order to be coupled to the fastening members S.

In addition, the coupling member 120 may include a bracket device 160, a lower yoke 170, and a ramp 180. Although the present embodiment describes a case in which the coupling member 120 includes the bracket device 160, the lower yoke 170, and the ramp 180 by way of example, the present invention is not limited thereto. That is, the coupling member 120 may include all components fixedly installed on the press base 140.

The press base 140 may be formed by press processing and include insertion parts 142 formed in respective positions corresponding to those of the insertion holes H and having the fastening members S inserted thereinto in order to mount the coupling member 120.

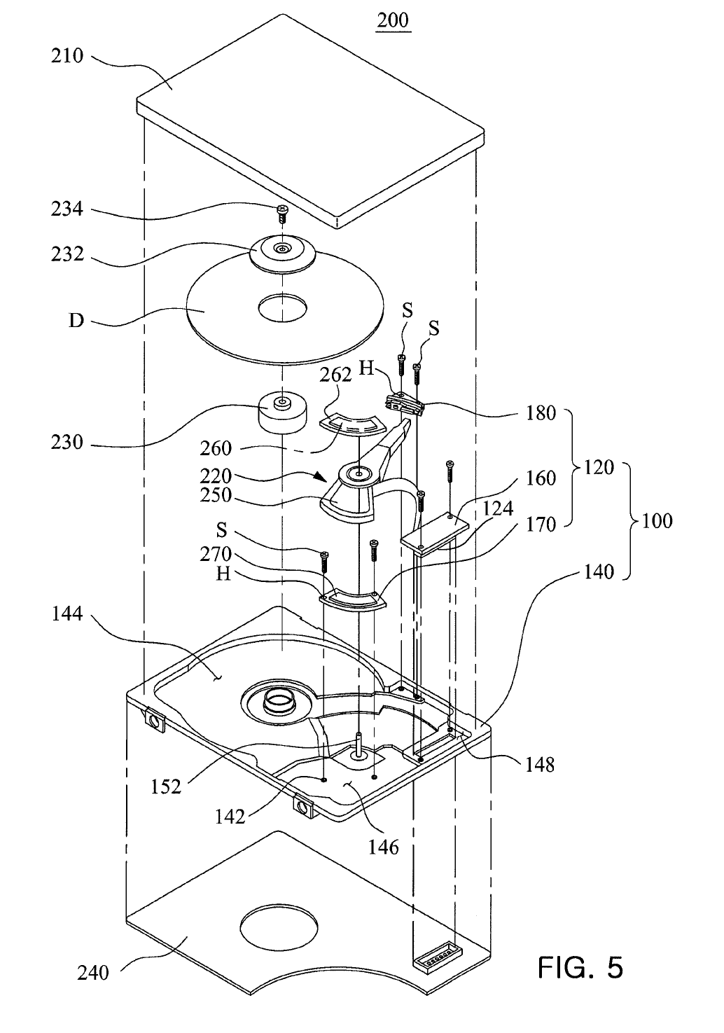

In addition, the press base 140 may configure a housing forming an outer appearance together with a cover 210 (See FIG. 5) in the recording disk driving device 200 (See FIG. 5) and include a disk disposing part 144, a head stack assembly disposing part 146, and a bracket device disposing part 148.

Meanwhile, after basic shapes of the disk disposing part 144, the head stack assembly disposing part 146, and the bracket device disposing part 148 is manufactured by press processing, a final shape of the press base 140 may be formed by bending or cutting, which is additional processing.

That is, the press base 140 may be manufactured by a single process through the press processing or a single process and additional processing, unlike the base manufactured in the post-processing scheme according to the related art in which aluminum (Al) is die-cast and a burr, or the like, generated due to the die-casting is then removed.

That is, the disk disposing part 144, the head stack assembly disposing part 146, and the bracket device disposing part 148 included in the press base 140 may be formed by disposing a lightweight alloy steel sheet such as a cold rolled steel sheet (SPCC, SPCE, or the like), a hot rolled steel sheet, a stainless steel, a boron or magnesium alloy, or the like, in a press mold and pressing the lightweight alloy steel sheet at a predetermined pressure.

As described above, since the press base 140 is manufactured by the press processing, a process time and energy consumption may be significantly reduced, whereby a manufacturing yield may be improved.

Meanwhile, the disk disposing part 144 may have a disk D disposed thereon and have a generally circular shape so as to correspond to a shape of the disk D.

More specifically, the disk disposing part 144 may be formed by depressing a partial region of the press base 140 downwardly in an axial direction and receive the disk D disposed therein.

In addition, the head stack assembly disposing part 146 may be formed to be adjacent to the disk disposing part 144 and have the HSA 220 (See FIG. 5) mounted thereon.

Further, the bracket device disposing part 148 may be formed to be adjacent to the head stack assembly disposing unit 146 and have the bracket device 160 installed thereat.

Meanwhile, the insertion part 142 may be provided with a fastening hole 142a into which the fastening member S is inserted and be bent to overlap so as to have a mutual contact part 142b extended and protruded from an upper surface of the press base, as shown in more detail in FIG. 3.

In addition, the insertion part 142 may be provided with a notch 142c formed in an upper portion of the mutual contact part 142b and facilitating bending of the insertion part 142 in a case in which the insertion part 142 is bent to have an overlapping portion thereof.

In addition, a cross section of the notch 142c may have a square shape. However, the cross section of the notch 142c is not limited to having the square cross section, but may also have, for example, a trapezoidal shape as shown in a modified example of FIG. 4.

That is, the cross section of the notch 142c may have any shape capable of facilitating bending of the insertion part 142 in a case in which the insertion part 142 is bent to overlap.

In addition, the insertion part 142 may include a screw part (not shown) formed in an inner surface thereof so that the fastening member S may be screwed thereto.

Meanwhile, the insertion part 142 may have an inner diameter smaller than that of the insertion hole H described above. Therefore, at the time of fastening of the fastening member S, the insertion part 142 may be elastically deformed to thereby press the fastening member S.

As a result, coupling force between the coupling member 120 and the press base 140 may be increased.

In other words, the insertion part 142 may have improved strength due to the shape in which it is bent to overlap. Therefore, since permanent deformation of the insertion part 142 may be suppressed, the insertion part 142 may be formed to have a relatively smaller diameter.

As a result, the insertion part 142 has an inner diameter smaller than that of the insertion hole H, such that the fastening member S may be fastened on the insertion part 142 in a press-fitting scheme. Therefore, coupling force between the coupling member 120 and the press base 140 may be increased.

In addition, the press base 140 may be provided with a dent part 150 formed in a lower end portion of the insertion part 142 and having a sealing member 190 insertedly mounted therein.

Further, the sealing member 190 may be a sealing tape and be attached to the above-mentioned dent part 150.

However, since the insertion part 142 is bent so as to have the mutual contact part 142b as described above, an adhesion area of the sealing member 190 may be reduced as compared to a case in which the insertion part having the fastening member S inserted thereinto is formed in the press base 140 by burring.

That is, in the case in which the insertion part having the fastening member S inserted thereinto is formed in the press base 140 by the burring, a space in which a burring die is installed needs to be formed in the press base 140. However, since the insertion part 142 according to the present embodiment is bent so as to have the mutual contact part 142b, the space in which the burring die is installed needs not to be formed in the press base 140.

Therefore, a size of a portion at which the insertion part 142 is formed may be reduced, such that a region at which the sealing member 190 for sealing is installed may be reduced.

Therefore, the size of the sealing member 190 may be relatively reduced, and manufacturing costs of the base assembly 100 may also be reduced.

As described above, the insertion part 142 may have improved strength due to the shape in which it is bent to overlap. Therefore, since permanent deformation of the insertion part 142 may be suppressed, the insertion part 142 may be formed to have a relatively smaller diameter.

As a result, the insertion part 142 has an inner diameter smaller than that of the insertion hole H, such that the fastening member S may be fastened on the insertion part 142 in a press-fitting scheme. Therefore, coupling force between the coupling member 120 and the press base 140 may be increased.

In addition, a size of a portion in which the insertion part 142 is formed is reduced, such that a region at which the sealing member 190 for sealing is installed may be reduced.

Therefore, the size of the sealing member 190 may be relatively reduced, and manufacturing costs of the base assembly 100 may also be reduced.

Hereinafter, a recording disk driving device according to an embodiment of the present invention will be described with reference to the accompanying drawings.

FIG. 5 is an exploded perspective view showing a recording disk driving device according to an embodiment of the present invention.

Referring to FIG. 5, a recording disk driving device 200 according to the embodiment of the present invention may include a base assembly 100, a head stack assembly (HSA) 220, a spindle motor 230, and a main circuit board 240.

Meanwhile, the base assembly 100 may include a coupling member 120 and a press base 140.

However, in FIG. 5, reference numerals of components included in the base assembly 100 are not used in detail. Therefore, detailed reference numerals will be described with reference to FIGS. 1 through 4.

The coupling member 120 may be provided with insertion holes H into which fastening members S are inserted. In addition, at least one coupling member 120 may be fixedly installed on the press base 140.

Meanwhile, the fastening member S may be a screw, and the coupling member 120 provided with the insertion holes H may include screw parts (not shown) formed therein in order to be coupled to the fastening members S.

In addition, the coupling member 120 may include a bracket device 160, a lower yoke 170, and a ramp 180. Although the present embodiment describes a case in which the coupling member 120 includes the bracket device 160, the lower yoke 170, and the ramp 180 by way of example, the present invention is not limited thereto. That is, the coupling member 120 may include all components fixedly installed on the press base 140.

The press base 140 may be formed by press processing and include insertion parts 142 each formed in positions corresponding to those of the insertion holes H and having the fastening members S inserted thereinto in order to mount the coupling member 120.

In addition, the press base 140 may configure a housing forming an outer appearance together with a cover 210 in the recording disk driving device 200 and include a disk disposing part 144, a head stack assembly disposing part 146, and a bracket device disposing part 148.

Meanwhile, after basic shapes of the disk disposing part 144, the head stack assembly disposing part 146, and the bracket device disposing part 148 is manufactured by press processing, a final shape of the press base 140 may be formed by bending or cutting, which is additional processing.

That is, the press base 140 may be manufactured by a single process through the press processing or a single process and additional processing, unlike the base manufactured in the post-processing scheme according to the related art in which aluminum (Al) is die-cast and a burr, or the like, generated due to the die-casting is then removed.

That is, the disk disposing part 144, the head stack assembly disposing part 146, and the bracket device disposing part 148 included in the press base 140 may be formed by disposing a lightweight alloy steel sheet such as a cold rolled steel sheet (SPCC, SPCE, or the like), a hot rolled steel sheet, a stainless steel, a boron or magnesium alloy, or the like, in a press mold and pressing the lightweight alloy steel sheet at a predetermined pressure.

As described above, since the press base 140 is manufactured by the press processing, a process time and energy consumption may be significantly reduced, whereby a manufacturing yield may be improved.

Meanwhile, the disk disposing part 144 may have the disk D disposed thereon and have a generally circular shape so as to correspond to a shape of the disk D.

More specifically, the disk disposing part 144 may be formed by depressing a partial region of the press base 140 downwardly in an axial direction and receive the disk ID therein.

In addition, the head stack assembly disposing part 146 may be formed to be adjacent to the disk disposing part 144 and have the HSA 220 mounted thereon.

Further, the bracket device disposing part 148 may be formed to be adjacent to the head stack assembly disposing unit 146 and have the bracket device 160 installed thereon.

Meanwhile, the insertion part 142 may be provided with a fastening hole 142a into which the fastening member S is inserted and be bent to have an overlapping portion thereof, a mutual contact part 142b, extended and protruded from an upper surface of the press base.

In addition, the insertion part 142 may be provided with a notch 142c formed in an upper portion of the mutual contact part 142b and facilitating bending of the insertion part 142 in a case in which the insertion part 142 is bent to overlap.

In addition, a cross section of the notch 142c may have a square shape. However, the cross section of the notch 142c is not limited to having the square cross section, but may also have, for example, a trapezoidal shape as shown in a modified example of FIG. 4.

That is, the cross section of the notch 142c may have any shape capable of facilitating bending of the insertion part 142 in the case in which the insertion part 142 is bent to overlap.

In addition, the insertion part 142 may include a screw part (not shown) formed on an inner surface thereof so that the fastening member S may be screwed thereto.

Meanwhile, the insertion part 142 may have an inner diameter smaller than that of the insertion hole H described above. Therefore, at the time of fastening of the fastening member S, the insertion part 142 may be elastically deformed to thereby press the fastening member S.

As a result, coupling force between the coupling member 120 and the press base 140 may be increased.

In other words, the insertion part 142 may have improved strength due to the shape in which it is bent to have an overlapping portion. Therefore, since permanent deformation of the insertion part 142 may be suppressed, the insertion part 142 may be formed to have a relatively smaller diameter.

As a result, the insertion part 142 has an inner diameter smaller than that of the insertion hole H, such that the fastening member S may be fastened on the insertion part 142 in a press-fitting scheme. Therefore, coupling force between the coupling member 120 and the press base 140 may be increased.

In addition, the press base 140 may be provided with a dent part 150 formed in a lower end portion of the insertion part 142 and having a sealing member 190 insertedly mounted therein.

Further, the sealing member 190 may be a sealing tape and be attached to the above-mentioned dent part 150.

However, since the insertion part 142 is bent so as to have the mutual contact part 142b as described above, an adhesion area of the sealing member 190 may be reduced as compared to a case in which the insertion part having the fastening member S inserted thereinto is formed in the press base 140 by burring.

That is, in a case in which the insertion part having the fastening member S inserted thereinto is formed in the press base 140 by the burring, a space in which a burring die is installed needs to be formed in the press base 140. However, since the insertion part 142 according to the present embodiment is bent so as to have the mutual contact part 142b, the space in which the burring die is installed needs not to be formed in the press base 140.

Therefore, a size of a portion in which the insertion part 142 is formed may be reduced, such that a region at which the sealing member 190 for sealing is installed may be reduced.

Therefore, the size of the sealing member 190 may be relatively reduced, and manufacturing costs of the base assembly 100 may also be reduced.

The head stack assembly 220 may be a component having a magnetic head mounted thereon and moving the magnetic head to a predetermined position to thereby write the data to the disk D or read the data written on the disk D.

In addition, the head stack assembly 220 may move the magnetic head to a predetermined position of the disk D by a voice coil motor (VCM) including a coil 250 and upper and lower magnets 260 and 270.

Here, each of the upper and lower magnets 260 and 270 disposed on upper and lower portions of the coil 250 provided in the VCM may be coupled to upper and lower yokes 262 and 170 in order to increase magnetic flux density and be fixed to the press base 140.

The VCM may be controlled by a servo control system and rotate the head stack assembly 220 around a pivot axis 152 in a direction according to the Fleming's left hand rule by interaction between current input by the coil 250 provided in the VCM and magnetic fields formed by the upper and lower magnets 260 and 270.

Here, an operation of the head stack assembly 220 will be schematically described. First, when an operation start command is input and the disk D thus starts to rotate, the VCM rotates a swing arm in a counterclockwise direction to move the magnetic head onto a writing surface of the disk D.

Further, when an operation stop command is input, the VCM rotates the swing arm in a clockwise direction to thereby allow the magnetic head to deviate from the disk D.

Meanwhile, the magnetic head deviating from the writing surface of the disk D may be parked in a ramp 280 disposed outside the disk D.

Here, the ramp 180 spaces the magnetic head from the disk D by a predetermined interval in a case in which the magnetic head moves to the disk D, simultaneously with parking the magnetic head, whereby the data of the disk D may be stably read.

Meanwhile, the head stack assembly 220 may be electrically connected to the main circuit board 240 disposed on the bottom surface of the press base 140 so as to rotate the swing arm by providing driving force to the VCM.

The configuration described above may be implemented through the bracket device 160 including a terminal 124. That is, the main circuit board 240 and the head stack assembly 220 may be electrically connected to each other by the bracket device 160.

Meanwhile, the bracket device 160 may be a component of the HSA 220 and include a connector (not shown) connecting the HSA 220 to the main circuit board 240 disposed on a bottom surface of the press based 140.

Meanwhile, the spindle motor 230, a component for rotating the disk D, may be fixedly installed at the center of the disk disposing part 144 of the press base 140.

The disk D may be mounted on the spindle motor 230 to thereby rotate by driving of the spindle motor 230, and have a writing surface to which data is written.

In addition, the spindle motor 230 may include a clamp 232 fastened to an upper end portion thereof by a screw 234 in order to firmly fix the disk D thereto.

Further, although FIG. 5 shows a case in which a single disk D is mounted on the spindle motor 230, the present invention is not limited thereto. That is, one or more disk may be mounted on the spindle motor 230.

Further, in a case in which a plurality of disks D are mounted on the spindle motor 230, a ring shaped spacer may be disposed between the plurality of disks D in order to maintain an interval therebetween.

As described above, the insertion part 142 may have improved strength due to the shape in which it is bent to overlap. Therefore, since permanent deformation of the insertion part 142 may be suppressed, the insertion part 142 may be formed to have a relatively smaller diameter.

As a result, the insertion part 142 has an inner diameter smaller than that of the insertion hole H, such that the fastening member S may be fastened on the insertion part 142 in a press-fitting scheme. Therefore, coupling force between the coupling member 120 and the press base 140 may be increased.

In addition, a size of a portion at which the insertion part 142 is formed is reduced, such that a region at which the sealing member 190 for sealing is installed may be reduced.

Therefore, the size of the sealing member 190 may be reduced, and manufacturing costs of the base assembly 100 may also be reduced.

As set forth above, according to the embodiments of the present invention, the coupling member may be coupled to the press base through the insertion part, whereby the coupling force between the press base and the coupling member may be increased.

In addition, the size of a sealing tape is reduced by the insertion part, whereby manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. A base assembly comprising:
at least one coupling member provided with insertion holes having fastening members inserted thereinto; and
a press base formed by press processing and including insertion parts each formed in positions corresponding to those of the insertion holes and having the fastening members inserted thereinto in order to mount the coupling member,
each of the insertion parts being provided with a fastening hole formed to have the fastening member inserted thereinto, and being bent to overlap so as to have a mutual contact part extended and protruded from an upper surface of the press base.

2. The base assembly of claim 1, wherein the press base is provided with a dent part formed in a lower end portion of the insertion part and having a sealing member insertedly mounted therein.

3. The base assembly of claim 1, wherein the insertion part is provided with a notch formed in an upper portion of the mutual contact part and facilitating bending of the insertion part in a case in which the insertion part is bent to overlap.

4. The base assembly of claim 3, wherein a cross section of the notch has a square shape or a trapezoidal shape.

5. The base assembly of claim 1, wherein the insertion part has an inner diameter smaller than that of the insertion hole to thereby press the fastening member.

6. A recording disk driving device comprising:
a base assembly including at least one coupling member provided with insertion holes having fastening members inserted thereinto and a press base including insertion parts each formed in positions corresponding to those of the insertion holes and having the fastening members inserted thereinto in order to mount the coupling member;
a head stack assembly rotatably installed on the press base; and
a spindle motor installed on the press base so as to be spaced apart from the head stack assembly,
each of the insertion parts being provided with a fastening hole formed to have the fastening member inserted thereinto and being bent to overlap so as to have a mutual contact part extended and protruded from an upper surface of the press base.

7. The recording disk driving device of claim 6, wherein the press base is provided with a dent part formed in a lower end portion of the insertion part and having a sealing member insertedly mounted therein.

8. The recording disk driving device of claim 6, wherein the insertion part is provided with a notch formed in an upper portion of the mutual contact part and facilitating bending of the insertion part in a case in which the insertion part is bent to overlap.

9. The recording disk driving device of claim 8, wherein a cross section of the notch has a square shape or a trapezoidal shape.

10. The recording disk driving device of claim 6, wherein the insertion part has an inner diameter smaller than that of the insertion hole to thereby press the fastening member.
